(19) United States
(12) Patent Application Publication
(10) Pub. No.: US 2006/0214647 A1
(43) Pub. Date: Sep. 28, 2006

(54) DC-DC converter

(75) Inventors: Makoto Ishimaru, Osaka (JP); Takuya Ishii, Osaka (JP); Mikio Motomori, Osaka (JP); Takashi Ryu, Kyoto (JP); Hirohisa Tanabe, Kyoto (JP); Hiroki Akashi, Osaka (JP); Tomoya Shigemi, Osaka (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/384,247

(22) Filed: Mar. 21, 2006

(30) Foreign Application Priority Data
Mar. 24, 2005 (JP) 2005-086731

(51) Int. Cl. G05F 1/00

(52) U.S. Cl. 323/222

(57) ABSTRACT

A current detector detects a current flowing through a high-side switch to output a current detection signal. When the current detection signal is lower than an error signal which is generated based on the difference between an output voltage and a reference voltage, a comparator outputs a signal. A timer outputs a signal a predetermined time after the high-side switch is turned ON. When the timer outputs the signal and the comparator outputs the signal, the high-side switch is turned OFF.

### BACKGROUND OF THE INVENTION

The present invention relates to a DC-DC converter for supplying a stable DC power to various electronic devices and specifically to a step-down DC-DC converter which operates based on an OFF period-controlled scheme.

In general, the step-down DC-DC converter (hereinafter, sometimes simply referred to as “DC-DC converter”) is formed by an inductor and a high-side switch and low-side switch which are connected in series between a voltage input terminal and a ground node. The high-side switch and low-side switch are alternately turned ON and OFF, whereby the inductor repeats accumulation and release of magnetic energy. An alternating voltage generated in this process is rectified and then supplied as an output voltage to an external load.

The output voltage of the DC-DC converter is regulated based on the ratio of ON period within one cycle of the high-side switch. The current flowing through the inductor (hereinafter, also referred to as “inductor current”) has a triangular waveform which alternately rises and falls according to ON/OFF of the switches. In a current mode controlling scheme, in general, the ON period or OFF period of the high-side switch is controlled by controlling the peak or trough value of the inductor current.

In an ON period-controlled scheme, it is necessary to detect a current flowing through the high-side switch. Therefore, a current detection circuit and peripheral circuits thereof are formed on the power-supply side. However, to carry out correct current detection with an input voltage which is expected to vary, the circuit structure becomes relatively complicated. On the contrary, in an OFF period-controlled scheme where a current flowing through the low-side switch is detected, the current detection circuit and peripheral circuits thereof are formed on the ground side, and therefore, the circuit structure is relatively simple.

In recent years, the output voltage has been decreasing, and accordingly, the ON period of the high-side switch has become shorter. For example, in a DC-DC converter which outputs a DC voltage of 1 V based on the switching frequency of 2 MHz and the input voltage of 5 V, the ON-period of the low-side switch is 400 nsec, whereas the ON-period of the high-side switch is 100 nsec. In the ON period-controlled scheme, it is necessary to perform current detection and circuit control within a short time period during which the high-side switch is ON. In the OFF period-controlled scheme, it is only necessary to perform current detection and circuit control within a time period during which the high-side switch is OFF. Thus, the OFF period-controlled scheme can provide a relatively long control time.

FIG. 10 shows a circuit structure of a conventional step-down DC-DC converter which operates based on an OFF period-controlled scheme. A high-side switch 53 and low-side switch 54 are complementarily controlled between ON and OFF by an RS latch 56. When the high-side switch 53 is turned ON, the difference between input voltage Vi and output voltage Vo (Vi−Vo) is applied to an inductor 10. Accordingly, an inductor current flowing through the inductor 10 linearly increases, and magnetic energy is accumulated in the inductor 10. When the high-side switch 53 is turned OFF, output voltage Vo is applied to the inductor 10 in a reverse direction. Accordingly, the inductor current linearly decreases, and magnetic energy is released from the inductor 10. A current detector 31 converts the current flowing through the low-side switch 54 to a voltage, thereby generating current detection voltage Vc1. The inductor current is smoothed by a capacitor 20, and the smoothed DC current is supplied to an unshown output load.

An error amplifier 40 receives fed-back output voltage Vo of the DC-DC converter at the inverting input terminal and reference voltage Vr at the non-inverting input terminal. A comparator 52 receives error signal Ve output from the error amplifier 40 at the non-inverting input terminal and current detection signal Vc1 output from the current detector 31 at the inverting input terminal. When the inductor current decreases such that current detection signal Vc1 is lower than error signal Ve, signal ST output from the comparator 52 is inverted to H level. Herein, signal ST is a signal for setting an RS latch 56. When signal ST transitions to H level, the high-side switch 53 is turned ON, and charging of the inductor 10 is started. The reset input terminal of the RS latch 56 is connected to a timer 55 for setting the ON period of the high-side switch 53. The timer 55 outputs signal CK a predetermined time after the high-side switch 53 is turned ON. When receiving signal CK, the RS latch 56 turns OFF the high-side switch 53.

Through the above operation, the DC-DC converter supplies a DC power which is constant even with a variation in the output load. For example, it is assumed that output voltage Vo decreases from a desired value due to an increase in the output load, or the like. The error amplifier 40 detects the decrease of output voltage Vo to increase error signal Ve. As a result, the time required for current detection signal Vc1, which gradually decreases, to reach the level of error signal Ve becomes shorter. That is, the OFF period of the high-side switch 53 becomes shorter. In the meanwhile, the ON period of the high-side switch 53, which is set by the timer 55, is constant. Accordingly, the inductor current increases, the power supplied to the capacitor 20 also increases, and output voltage Vo increases back to the desired value. For example, on the contrary, it is assumed that output voltage Vo increases from the desired value due to a decrease in the output load, or the like. In this case, the error amplifier 40 decreases error signal Ve so that the OFF period of the high-side switch 53 becomes longer. In the meanwhile, the ON period of the high-side switch 53 is constant, and accordingly, the inductor current decreases. Therefore, the power supplied to the capacitor 20 decreases, and once-increased output voltage Vo decreases back to the desired value.

The above OFF period-controlled, step-down DC-DC converter has a period where the high-side switch 53 is once turned OFF, and current detection signal Vc1 gradually decreases to sink below error signal Ve so that the high-side switch 53 is turned ON again (hereinafter, sometimes referred to as “minimum OFF period”). Therefore, when output voltage Vo is substantially equal to input voltage Vi, the high-side switch 53 is periodically turned OFF only for the minimum OFF period and, every time the high-side switch 53 is turned OFF, output voltage Vo decreases.

When the output load sharply increases, it is necessary to increase output voltage Vo more quickly to recover the desired value. However, the increase speed of the inductor current is relatively slow because the high-side switch 53 is periodically turned OFF only for the minimum OFF period, and therefore, quick recovery of the desired value is difficult. As a result, the decrease of output voltage Vo, i.e., the undershoot which occurs in output voltage Vo, becomes greater.

### SUMMARY OF THE INVENTION

In view of the above problems, an objective of the present invention is to provide an OFF period-controlled, step-down DC-DC converter wherein a decrease in the output voltage that is stable in the vicinity of the level of the input voltage is suppressed and, in the case of a decrease in the output voltage, the output voltage quickly recovers a desired value.

A measure taken by the present invention for achieving the above objective is a step-down DC-DC converter, comprising: an inductor; a smoother for smoothing a current flowing through the inductor to generate an output voltage of the DC-DC converter; a current detector for generating a current detection signal according to a magnitude of the current flowing through the inductor; an output error detector for generating an error signal according to a difference between the output voltage of the DC-DC converter and a supplied reference voltage; and a controller for controlling supply of a power to the inductor such that when the current detection signal sinks below the error signal, supply of the power to the inductor is started, and when a predetermined time elapses since the start of the supply of the power and the current detection signal exceeds the error signal, the supply of the power is stopped.

According to this invention, the power supply control to the inductor is such that the power supply is continued till the current detection signal exceeds the error signal even after the predetermined time has elapsed since the start of the power supply. Therefore, the period of power supply to the inductor is substantially extended. Thus, when the output voltage is stable in the vicinity of the level of the input voltage, the decrease in the output voltage is suppressed and, when the output voltage is decreased, the output voltage quickly recovers a desired value.

Specifically, the current detector includes a first current detector for generating a first current detection signal according to a magnitude of a current flowing from a voltage input terminal to the inductor, and a second current detector for generating a second current detection signal according to a magnitude of a current flowing from a ground node to the inductor. The controller includes a first comparator for comparing the first current detection signal and the error signal, a second comparator for comparing the second current detection signal and the error signal, a switch provided between the voltage input terminal and the inductor, a timer which is triggered by a turning-ON of the switch to count the predetermined time, and a driving element for driving the switch such that when the second comparator indicates that the second current detection signal is lower than the error signal, the driving element turns ON the switch, and when the timer finishes counting the predetermined time and the first comparator indicates that the first current detection signal is higher than the error signal, the driving element turns OFF the switch.

Specifically, the controller includes: a comparator for comparing the current detection signal and the error signal; a switch provided between a voltage input terminal and the inductor; a timer which is triggered by a turning-ON of the switch to count the predetermined time; and a driving element for driving the switch such that when the comparator indicates that the current detection signal is lower than the error signal, the driving element turns ON the switch, and when the timer finishes counting the predetermined time and the comparator indicates that the current detection signal is higher than the error signal, the driving element turns OFF the switch.

Specifically, the controller includes: an offset adding element for adding an offset voltage to the error signal to output a larger one of the error signal and the signal to which the offset voltage is added as the first error signal and outputs the other as the second error signal; a first comparator for comparing the current detection signal and the first error signal; a second comparator for comparing the current detection signal and the second error signal; a switch provided between a voltage input terminal and the inductor; a timer which is triggered by a turning-ON of the switch to count the predetermined time; and a driving element for driving the switch such that when the second comparator indicates that the current detection signal is lower than the second error signal, the driving element turns ON the switch, and when the timer finishes counting the predetermined time and the first comparator indicates that the current detection signal is higher than the first error signal, the driving element turns OFF the switch.

Specifically, the controller includes: an offset adding element for adding an offset voltage to the current detection signal to output a smaller one of the current detection signal and the signal to which the offset voltage is added as the first error signal and outputs the other as the second error signal; a first comparator for comparing the first current detection signal and the error signal; a second comparator for comparing the second current detection signal and the error signal; a switch provided between a voltage input terminal and the inductor; a timer which is triggered by a turning-ON of the switch to count the predetermined time; and a driving element for driving the switch such that when the second comparator indicates that the second current detection signal is lower than the error signal, the driving element turns ON the switch, and when the timer finishes counting the predetermined time and the first comparator indicates that the first current detection signal is higher than the error signal, the driving element turns OFF the switch.

Preferably, the controller includes an offset setting element for setting the offset voltage such that: when a variation in the output voltage of the DC-DC converter is relatively large, the offset setting element sets an absolute value of the offset voltage to be relatively large; and when a variation in the output voltage of the DC-DC converter is relatively small, the offset setting element sets the absolute value of the offset voltage to be relatively small.

Specifically, the offset setting element changes the offset voltage according to a variation in the error signal.

As described above, according to the present invention, when the output voltage of an OFF period-controlled, step-down DC-DC converter is stable in the vicinity of the level of the input voltage, the decrease in the output voltage is suppressed. Further, even if the output voltage is temporarily decreased due to an external factor, or the like, the output voltage quickly recovers its original value. With these features, an extremely stable DC power is supplied.

### BRIEF DESCRIPTION OF THE DRAWINGS

FIG. 1 shows a circuit structure of a DC-DC converter according to embodiment 1.

FIG. 2 is an operation waveform chart of the DC-DC converter according to embodiment 1.

FIG. 3 shows a circuit structure of a DC-DC converter according to embodiment 2.

FIG. 4 is an operation waveform chart of the DC-DC converter according to embodiment 2.

FIG. 5 shows a circuit structure of a DC-DC converter according to embodiment 3.

FIGS. 6A and 6B show circuit structures of an offset adding element.

FIG. 7 is an operation waveform chart of the DC-DC converter according to embodiment 3.

FIG. 8 shows another circuit structure of the DC-DC converter where an offset voltage is added to a current detection signal.

FIG. 9 shows a circuit structure of a DC-DC converter according to embodiment 4.

FIG. 10 shows a circuit structure of a conventional OFF period-controlled, step-down DC-DC converter.

### DESCRIPTION OF THE PREFERRED EMBODIMENTS

Hereinafter, best modes for carrying out the present invention are described with reference to the drawings.

### Embodiment 1

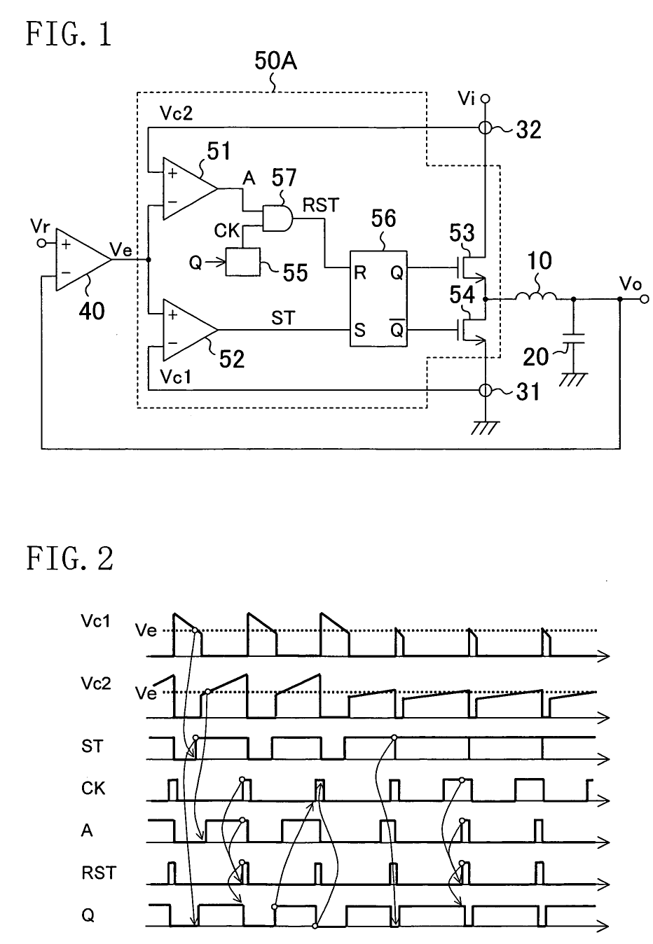

FIG. 1 shows a circuit structure of a DC-DC converter according to embodiment 1. The DC-DC converter of embodiment 1 includes an inductor 10, a capacitor (smoother) 20, current detectors 31 and 32, an error amplifier (output error detector) 40, and a controller 50A. The controller 50A includes comparators 51 and 52, a high-side switch 53, a low-side switch 54, a timer 55, an RS latch (driving element) 56, and an AND gate 57. It should be noted that, among these components, those equivalent to the components of the conventional DC-DC converter are denoted by the same reference numerals used in FIG. 10.

The high-side switch 53 and the low-side switch 54 are connected in series between an voltage input terminal (voltage Vi) and a ground node. The inductor 10 and the capacitor 20 are connected between a connection point of the switches 53 and 54 and the output terminal of the DC-DC converter to constitute a filter. The high-side switch 53 and the low-side switch 54 are connected to the RS latch 56 and complementarily controlled between ON and OFF. The low-side switch 54 only needs to work as a synchronous rectifier and, for example, can be replaced with a diode.

The current detector 31 detects a current which flows from the ground node to the inductor 10 via the low-side switch 54 when the low-side switch 54 is ON and converts the detected current to a voltage signal, thereby generating current detection signal Vc1. Likewise, the current detector 32 detects a current which flows from the voltage input terminal to the inductor 10 via the high-side switch 53 when the high-side switch 53 is ON and converts the detected current to a voltage signal, thereby generating current detection signal Vc2. The current detectors 31 and 32 may have resistances for current detection in series with the high-side switch 53 and the low-side switch 54 to detect voltages generated in the resistances. Alternatively, voltages at the both ends of ON resistances of the low-side switch 54 and the high-side switch 53 may be used as the detection signals.

The error amplifier 40 receives reference voltage Vr at the non-inverting input terminal and output voltage Vo at the inverting input terminal and outputs error signal Ve which is generated according to the error between reference voltage Vr and output voltage Vo. The comparator 52 receives error signal Ve at the non-inverting input terminal and current detection signal Vc1 at the inverting input terminal and outputs signal ST for setting the RS latch 56. The comparator 51 receives error signal Ve at the inverting input terminal and current detection signal Vc2 at the non-inverting input terminal and outputs signal A. The timer 55 receives signal Q from the RS latch 56 and outputs signal CK a predetermined time after signal Q transitions to the level at which the high-side switch 53 is turned ON. The AND gate 57 calculates a logical sum of signal A output from the comparator 51 and signal CK output from the timer 55 to output signal RST which resets the RS latch 56.

Next, an operation of the DC-DC converter of embodiment 1 is described with reference to the operation waveform chart of FIG. 2.

When the difference between the input and the output (Vi−Vo) is sufficiently large, the operation waveforms are as shown on the left of FIG. 2. That is, the high-side switch 53 is turned OFF, whereby current detection signal Vc1 gradually decreases. When this gradually-decreasing current detection signal Vc1 sinks below error signal Ve, signal ST transitions to H level, and accordingly, signal Q transitions to H level. As a result of the transition of signal Q to H level, the high-side switch 53 is turned ON, and current detection signal Vc2 gradually increases. When this gradually-increasing current detection signal Vc2 exceeds error signal Ve, signal A transitions to H level. However, at this point in time, the predetermined time has not elapsed since the start of the ON period of the high-side switch 53, and therefore, signal CK is not output, and signal RST is not output. Thereafter, the predetermined time elapses since the start of the ON period of the high-side switch 53, and signal CK is output, whereby signal RST is also output. Accordingly, the high-side switch 53 is turned OFF again. That is, when the difference between the input and the output is sufficiently large, the OFF period of the high-side switch 53 is controlled according to the output of signal CK.

When the difference between the input and the output (Vi−Vo) is sufficiently small, the operation waveforms are as shown on the right of FIG. 2. That is, although current detection signal Vc2 gradually increases as a result of turning ON the high-side switch 53, the increase of the inductor current is slow because the difference between the input and the output (Vi−Vo) is small, so that signal CK is output before this gradually-increasing current detection signal Vc2 reaches the level of error signal Ve. However, at this point in time, current detection signal Vc2 is not higher than error signal Ve, and signal A is at L level. Thus, signal RST is not output. Thereafter, when current detection signal Vc2 exceeds error signal Ve, signal A transitions to H level. As a result, signal RST is output, and the high-side switch 53 is turned OFF again. That is, the timing of turning OFF the high-side switch 53 is delayed from the predetermined time counted by the timer 55. In other words, the ON period of the high-side switch 53 is extended. When the high-side switch 53 is turned OFF, current detection signal Vc1 immediately sinks below error signal Ve. Accordingly, signal ST transitions to H level, and the high-side switch 53 is turned ON again. This period, during which the high-side switch 53 is OFF, is the minimum OFF period.

The operation waveforms obtained when output voltage Vo of the DC-DC converter of embodiment 1 is substantially equal to input voltage Vi are as shown in the right of FIG. 2. When output voltage Vo is stable in the vicinity of the level of input voltage Vi, the ON period of the high-side switch 53 is extended, while the minimum OFF period is shortened. Therefore, the decrease of output voltage Vo is suppressed. When output voltage Vo is decreased from a desired value due to an increase in an output load, error signal Ve increases. Thus, also in this case, the operation waveforms are as shown in the right of FIG. 2. That is, since the ON period of the high-side switch 53 is extended even when output voltage Vo decreases, the undershoot of output voltage Vo is minimized, and output voltage Vo quickly recovers the desired value.

### Embodiment 2

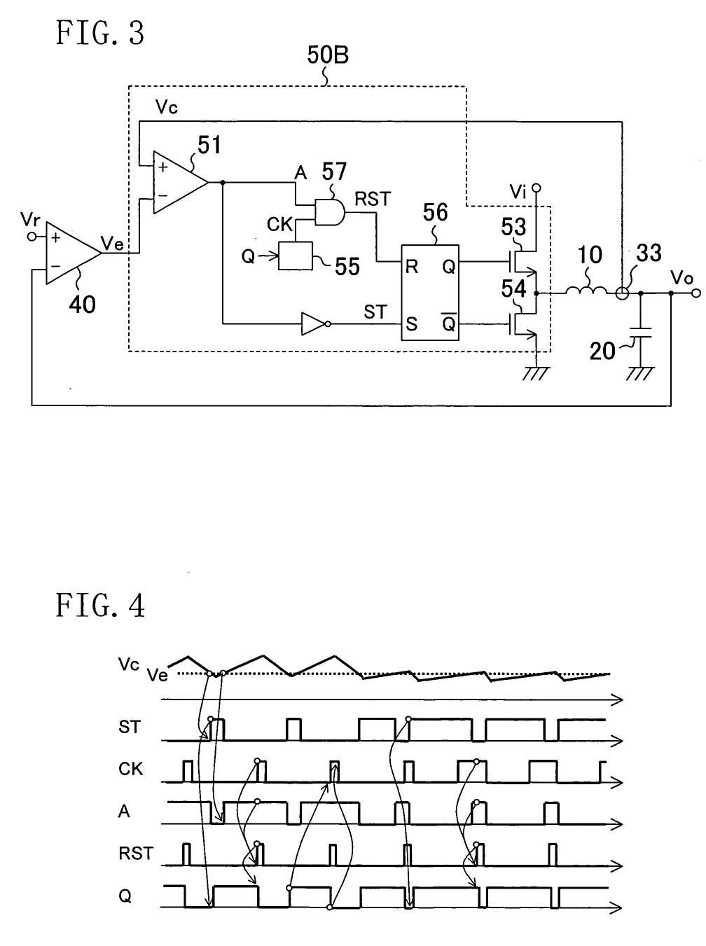

FIG. 3 shows a circuit structure of a DC-DC converter according to embodiment 2. In the DC-DC converter of embodiment 2, the current detectors 31 and 32 of the DC-DC converter of embodiment 1 are realized in the form of a single unit. Hereinafter, components equivalent to those of embodiment 1 are denoted by the same reference numerals, and the descriptions thereof are omitted while only the differences from embodiment 1 are described.

A current detector 33 detects an inductor current at a detection point between the inductor 10 and the output terminal of the DC-DC converter. The detection point may be between the connection point of the high-side switch 53 and low-side switch 54 and the inductor 10. Current detection signal Vc output from the current detector 33 is applied to the non-inverting input terminal of the comparator 51.

A controller 50B is different from the controller 50A of embodiment 1 only in that the comparator 52 is omitted. Signal ST, which is used for setting the RS latch 56, is the inverse of signal A output from the comparator 51. It should be noted that the comparator 51 may be omitted from the controller 50A of embodiment 1 such that signal A is the inverse of signal ST output from the comparator 52.

Next, an operation of the DC-DC converter of embodiment 2 is described with reference to the operation waveform chart of FIG. 4.

When the difference between the input and the output (Vi−Vo) is sufficiently large, the operation waveforms are as shown on the left of FIG. 4. That is, when current detection signal Vc which is gradually decreasing during the OFF period of the high-side switch 53 sinks below the level of error signal Ve, the high-side switch 53 is turned ON, and current detection signal Vc then starts gradually increasing. When current detection signal Vc exceeds error signal Ve, signal A transitions to H level. However, at this point in time, signal CK is not output, and therefore, signal RST is not output. Thereafter, signal CK is output, whereby signal RST is also output. Accordingly, the high-side switch 53 is turned OFF again.

When the difference between the input and the output (Vi−Vo) is sufficiently small, the operation waveforms are as shown on the right of FIG. 4. That is, signal CK is output before current detection signal Vc which is gradually increasing during the ON period of the high-side switch 53 reaches the level of error signal Ve. However, at this point in time, current detection signal Vc is not higher than error signal Ve. Thus, signal A is at L level, and signal RST is not output. Thereafter, when current detection signal Vc exceeds error signal Ve and signal A transitions to H level, signal RST is output, and the high-side switch 53 is turned OFF again. That is, the ON period of the high-side switch 53 is extended. When the high-side switch 53 is turned OFF, current detection signal Vc immediately sinks below error signal Ve. Accordingly, the high-side switch 53 is turned ON again.

As described above, the DC-DC converter of embodiment 2 includes a smaller number of current detectors and comparators and has a simple circuit structure as compared with the DC-DC converter of embodiment 1. The differences in operation which result from the differences in circuit structure are only that the H-level period of signal ST and the L-level period of signal A are shortened. Such differences do not deteriorate the effect of suppressing output voltage Vo when output voltage Vo is stable in the vicinity of the level of input voltage Vi or the effect of quickly recovering a desired value when output voltage Vo decreases.

In the DC-DC converter of embodiment 2, it is necessary to insert a resistance in series with the inductor 10 for detecting the inductor current, whereas this is not necessary in the DC-DC converter of embodiment 1. That is, the DC-DC converter of embodiment 1 has a smaller internal resistance. Therefore, the DC-DC converter of embodiment 1 has an advantage in view of the internal resistance over the DC-DC converter of embodiment 2.

### Embodiment 3

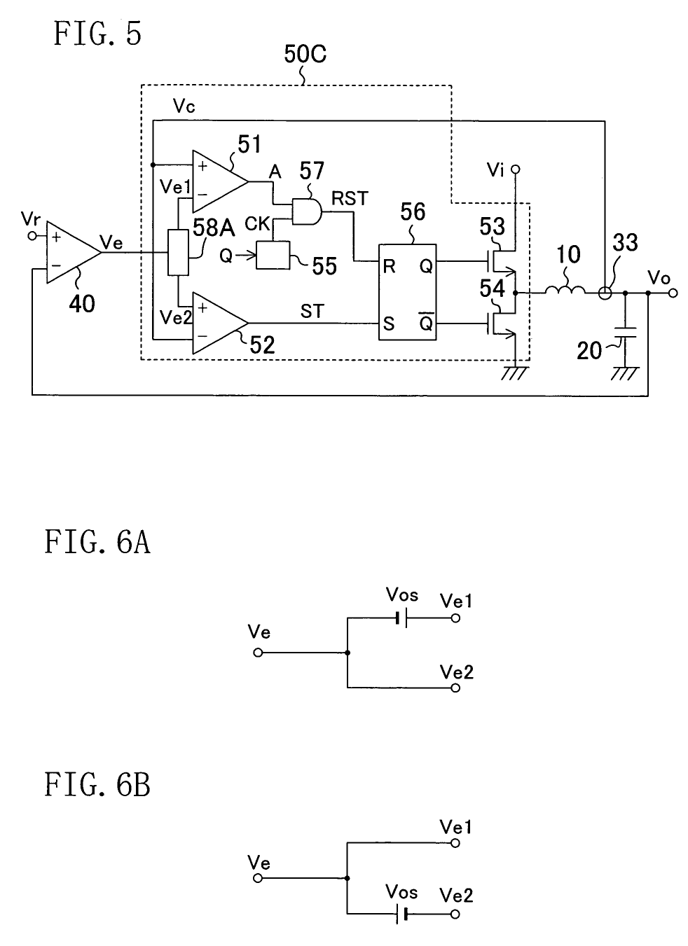

FIG. 5 shows a circuit structure of a DC-DC converter according to embodiment 3. In the DC-DC converter of embodiment 3, the current detectors 31 and 32 of the DC-DC converter of embodiment 1 are realized in the form of a single unit as in embodiment 2, and an offset voltage is added to error signal Ve. Hereinafter, components equivalent to those of embodiments 1 and 2 are denoted by the same reference numerals, and the descriptions thereof are omitted while only the differences from embodiments 1 and 2 are described.

A controller SOC includes an offset adding element 58A. FIGS. 6A and 6B show circuit structures of the offset adding element 58A. An example of the offset adding element 58A shown in FIG. 6A outputs the total of error signal Ve and positive offset voltage Vos added thereto as error signal Ve1 and, meanwhile, outputs error signal Ve as error signal Ve2. Another example of the offset adding element 58A shown in FIG. 6B outputs error signal Ve as error signal Ve1 and, meanwhile, outputs the total of error signal Ve and negative offset voltage Vos added thereto as error signal Ve2. That is, error signals Ve1 and Ve2 output from the offset adding element 58A are in a relationship that error signal Ve1 is higher than error signal Ve2 by offset voltage Vos. Error signal Ve1 is applied to the inverting input terminal of the comparator 51, and error signal Ve2 is applied to the non-inverting input terminal of the comparator 51.

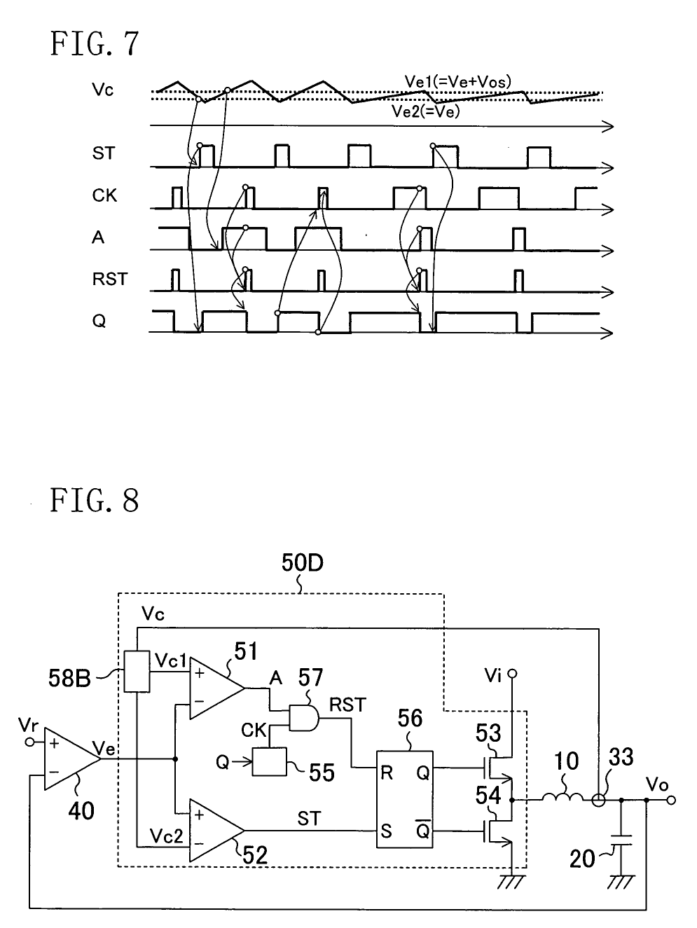

Next, an operation of the DC-DC converter of embodiment 3 is described with reference to the operation waveform chart of FIG. 7. Herein, it is assumed that the offset adding element 58A has the circuit structure shown in FIG. 6A.

When the difference between the input and the output (Vi−Vo) is sufficiently large, the operation waveforms are as shown on the left of FIG. 7. That is, when current detection signal Vc which is gradually decreasing during the OFF period of the high-side switch 53 sinks below the level of error signal Ve2 (=Ve), the high-side switch 53 is turned ON, and current detection signal Vc then starts gradually increasing. When current detection signal Vc exceeds error signal Ve2 and then error signal Ve1 (=Ve+Vos), signal A transitions to H level. However, at this point in time, signal CK is not output, and therefore, signal RST is not output. Thereafter, signal CK is output, whereby signal RST is also output. Accordingly, the high-side switch 53 is turned OFF again.

When the difference between the input and the output (Vi−Vo) is sufficiently small, the operation waveforms are as shown on the right of FIG. 7. That is, current detection signal Vc which is gradually increasing during the ON period of the high-side switch 53 exceeds error signal Ve2, and signal CK is output before current detection signal Vc reaches the level of error signal Ve1. However, at this point in time, current detection signal Vc is not higher than error signal Ve1. Thus, signal A remains at L level, and signal RST is not output. Thereafter, when current detection signal Vc exceeds error signal Ve1 and signal A transitions to H level, signal RST is output, and the high-side switch 53 is turned OFF again.

As described above, in the DC-DC converter of embodiment 3, a target value of current detection signal Vc which functions as a trigger to start the OFF period of the high-side switch 53, i.e., error signal Ve1, is higher than a target value which functions as a trigger to start the ON period, i.e., error signal Ve2. With this feature, the ON period of the high-side switch 53 is further extended as compared with embodiments 1 and 2. For example, when a decrease in output voltage Vo occurs, the ON period of the high-side switch 53 is extended at an earlier timing as compared with embodiments 1 and 2. In other words, the DC-DC converter of embodiment 3 is more sensitive to the decrease in output voltage Vo and operates to quickly recover an original desired value.

The above effects can be achieved also when offset voltage Vos is added not to error signal Ve but to current detection signal Vc. That is, the present invention may be implemented such that, as shown in FIG. 8, an offset adding element 58B is provided in a controller 50D of the DC-DC converter, current detection signal Vc1 is applied to the non-inverting input terminal of the comparator 51, and current detection signal Vc2 is applied to the inverting input terminal of the comparator 52. In this case, current detection signal Vc1 needs to be lower than current detection signal Vc2 by offset voltage Vos.

### Embodiment 4

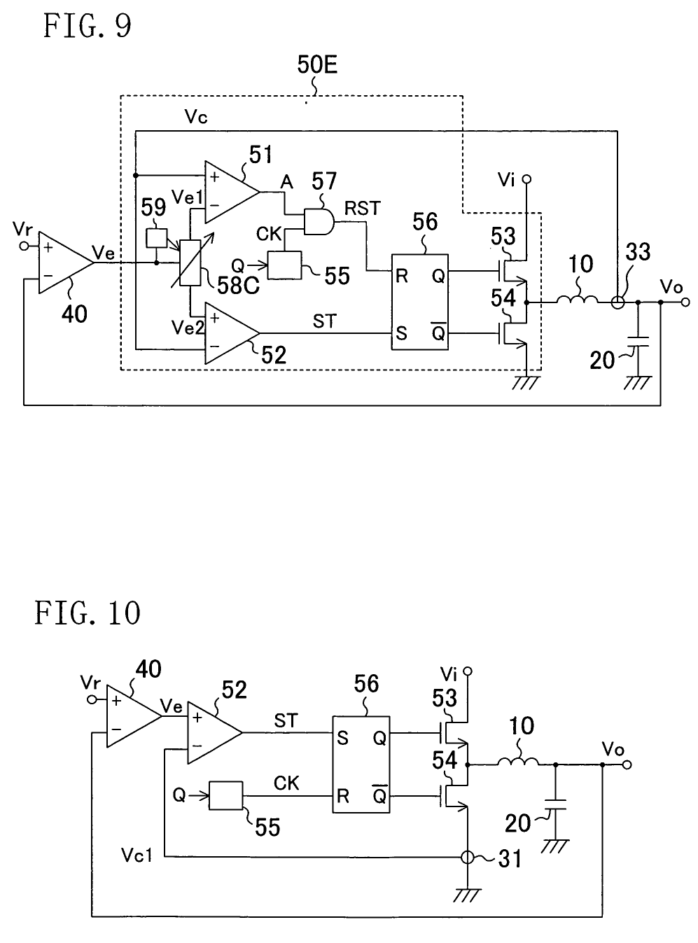

FIG. 9 shows a circuit structure of a DC-DC converter according to embodiment 4.

The DC-DC converter of embodiment 4 includes an offset adding element 58C for providing a variable offset voltage and an offset setting element 59 for setting the offset voltage in place of the offset adding element 58A of the DC-DC converter of embodiment 3. Hereinafter, components equivalent to those of embodiment 3 are denoted by the same reference numerals, and the descriptions thereof are omitted while only the differences from embodiment 3 are described.

In the previously-described DC-DC converter of embodiment 3, if the output is stable, the high-side switch 53 is turned OFF when current detection signal Vc exceeds error signal Ve1, and the OFF period lasts till current detection signal Vc sinks below error signal Ve2, i.e., till current detection signal Vc decreases by offset voltage Vos. Therefore, the minimum OFF period is relatively long. Thus, if the output is stable, offset voltage Vos is preferably zero. In view of such, in the DC-DC converter of embodiment 4, the offset voltage is variable, whereas it is fixed in embodiment 3.

As the variation in output voltage Vo increases, the offset setting element 59 increases offset voltage Vos which is added to error signal Ve by the offset adding element 58C. As the variation in output voltage Vo decreases, the offset setting element 59 changes offset voltage Vos to be close to zero. Specifically, the offset setting element 59 detects a variation in error signal Ve by, for example, differentiating error signal Ve, and changes offset voltage Vos according to the detected variation. Preferably, when error signal Ve is stable at a constant value, offset voltage Vos is set to zero.

Thus, according to the present invention, when the output of the DC-DC converter is variable, the DC-DC converter enters an operation state where a voltage at a certain level is set to offset voltage Vos, and the ON period of the high-side switch 53 is extended at an earlier timing. When the output of the DC-DC converter is stable, offset voltage Vos is set to substantially zero, and the minimum OFF period of the high-side switch 53 is controlled to be shortest. That is, the DC-DC converter of embodiment 4 is more sensitive to the decrease in output voltage Vo and operates to quickly recover an original desired value. On the other hand, when output voltage Vo is stable in the vicinity of the level of input voltage Vi, the decrease in output voltage Vo which is caused due to the minimum OFF period of the high-side switch 53 is suppressed.

The offset setting element 59 may detect a variation in a signal other than error signal Ve, for example, output voltage Vo, to change offset voltage Vos. Further, offset voltage Vos may be changed continuously or discretely. For example, offset voltage Vos may be switched between zero and a certain voltage other than zero according to the variation in error signal Ve.

In the structure where offset voltage Vos is added to current detection signal Vc as shown in FIG. 8, offset voltage Vos may be variable as described above.

What is claimed is:

1. A step-down DC-DC converter, comprising:
an inductor;
a smoother for smoothing a current flowing through the inductor to generate an output voltage of the DC-DC converter;
a current detector for generating a current detection signal according to a magnitude of the current flowing through the inductor;
an output error detector for generating an error signal according to a difference between the output voltage of the DC-DC converter and a supplied reference voltage; and
a controller for controlling supply of a power to the inductor such that
when the current detection signal sinks below the error signal, supply of the power to the inductor is started, and
when a predetermined time elapses since the start of the supply of the power and the current detection signal exceeds the error signal, the supply of the power is stopped.

2. The DC-DC converter of claim 1, wherein:
the current detector includes
a first current detector for generating a first current detection signal according to a magnitude of a current flowing from a voltage input terminal to the inductor, and
a second current detector for generating a second current detection signal according to a magnitude of a current flowing from a ground node to the inductor; and
the controller includes
a first comparator for comparing the first current detection signal and the error signal,
a second comparator for comparing the second current detection signal and the error signal,
a switch provided between the voltage input terminal and the inductor,
a timer which is triggered by a turning-ON of the switch to count the predetermined time, and
a driving element for driving the switch such that
when the second comparator indicates that the second current detection signal is lower than the error signal, the driving element turns ON the switch, and
when the timer finishes counting the predetermined time and the first comparator indicates that the first current detection signal is higher than the error signal, the driving element turns OFF the switch.

3. The DC-DC converter of claim 1, wherein the controller includes:
a comparator for comparing the current detection signal and the error signal;
a switch provided between a voltage input terminal and the inductor;
a timer which is triggered by a turning-ON of the switch to count the predetermined time; and
a driving element for driving the switch such that
when the comparator indicates that the current detection signal is lower than the error signal, the driving element turns ON the switch, and
when the timer finishes counting the predetermined time and the comparator indicates that the current detection signal is higher than the error signal, the driving element turns OFF the switch.

4. The DC-DC converter of claim 1, wherein the controller includes:
an offset adding element for adding an offset voltage to the error signal to output a larger one of the error signal and the signal to which the offset voltage is added as the first error signal and outputs the other as the second error signal;
a first comparator for comparing the current detection signal and the first error signal;
a second comparator for comparing the current detection signal and the second error signal;
a switch provided between a voltage input terminal and the inductor;
a timer which is triggered by a turning-ON of the switch to count the predetermined time; and
a driving element for driving the switch such that
when the second comparator indicates that the current detection signal is lower than the second error signal, the driving element turns ON the switch, and
when the timer finishes counting the predetermined time and the first comparator indicates that the current detection signal is higher than the first error signal, the driving element turns OFF the switch.

5. The DC-DC converter of claim 4, wherein the controller includes an offset setting element for setting the offset voltage such that:
when a variation in the output voltage of the DC-DC converter is relatively large, the offset setting element sets an absolute value of the offset voltage to be relatively large; and
when a variation in the output voltage of the DC-DC converter is relatively small, the offset setting element sets the absolute value of the offset voltage to be relatively small.

6. The DC-DC converter of claim 5, wherein the offset setting element changes the offset voltage according to a variation in the error signal.

7. The DC-DC converter of claim 1, wherein the controller includes:
an offset adding element for adding an offset voltage to the current detection signal to output a smaller one of the current detection signal and the signal to which the offset voltage is added as the first error signal and outputs the other as the second error signal;
a first comparator for comparing the first current detection signal and the error signal;
a second comparator for comparing the second current detection signal and the error signal;
a switch provided between a voltage input terminal and the inductor;
a timer which is triggered by a turning-ON of the switch to count the predetermined time; and
a driving element for driving the switch such that
when the second comparator indicates that the second current detection signal is lower than the error signal, the driving element turns ON the switch, and
when the timer finishes counting the predetermined time and the first comparator indicates that the first current detection signal is higher than the error signal, the driving element turns OFF the switch.

8. The DC-DC converter of claim 7, wherein the controller includes an offset setting element for setting the offset voltage such that:
when a variation in the output voltage of the DC-DC converter is relatively large, the offset setting element sets an absolute value of the offset voltage to be relatively large; and
when a variation in the output voltage of the DC-DC converter is relatively small, the offset setting element sets the absolute value of the offset voltage to be relatively small.

9. The DC-DC converter of claim 8, wherein the offset setting element changes the offset voltage according to a variation in the error signal.
